(19) United States
(12) Patent Application Publication
(10) Pub. No.: US 2003/0070101 A1
(43) Pub. Date: Apr. 10, 2003

(54) Method and apparatus for protecting personal information and for verifying identities

(76) Inventor: James S. Buscemi, Camarillo, CA (US)

Correspondence Address: RIORDAN & MCKINZIE, 300 SOUTH GRAND AVENUE, 29TH FLOOR, LOS ANGELES, CA, 90071, US

(21) Appl. No.: 10/267,350

(22) Filed: Oct. 9, 2002

Related U.S. Application Data
(60) Provisional application No. 60/328,367, filed on Oct. 9, 2001.

(51) Int. Cl. H04L 9/00

(52) U.S. Cl. 713/202

(57) ABSTRACT

The present invention provides a method and apparatus for protecting private information and for verifying the identity of an individual, preferably as part of a commercial transaction. The present invention utilizes an electronic data base which contains information regarding the individual and a personal key which is associated with the private information. In the preferred embodiment, the private information is a Social Security Number. Alternative embodiments of the present invention utilize keys which are single use keys, multi-use keys or keys which have an expiration date. Alternative embodiments allow for the key to be received through a web browser interface, over a telephone or by other common electronic communication means. The subscriber can also enable a verification block feature so as to prevent the use of the private information for a period of time, thereby combating identity theft.

### PRIORITY CLAIM

This application claims priority on U.S. Provisional Application No. 60/328,367 filed on Oct. 9, 2001. The disclosure of the foregoing is incorporated by reference herein as if set forth in full hereat.

### BACKGROUND OF THE INVENTION

1) Field of the Invention

The present invention relates generally to a method and apparatus for protecting personal information and for verifying identities.

2) Description of the Prior Art

A number of companies such as Verisign currently provide secure access to various data repositories. The data to be secured is encrypted and the receiving party is provided with a personal key to decipher and access the data. In essence, these types of services provide secure data exchange between two parties based on the party granting access giving the receiving party their personal key.

None of these services, however, provide the public with non-encryption means of protecting individual pieces of personal information, such as social security numbers.

### BRIEF DESCRIPTION OF THE DRAWINGS

The present invention is illustrated by way of example and not limitation in the following drawings, in which like references indicate similar elements, and in which:

FIG. 1 illustrates one embodiment of the present invention.

FIG. 2 illustrates an alternate embodiment of the present invention.

FIG. 3 illustrates yet another alternate embodiment of the present invention.

### DETAILED DESCRIPTION OF THE INVENTION

The present invention discloses a method and apparatus for protecting personal information and verifying identities. In the following description numerous specific details are set forth for the purposes of explanation, in order to provide a thorough understanding of the present invention. It will be evident, however, to one skilled in the art, that the present invention may be practiced without all these specific details. In other instances, well-known structures and devices are shown in block diagram form for clarity and in order not to obscure the details of the invention.

The present invention may be implemented within an electronic system including any computer system now known or hereafter developed. In one embodiment, such computer system may comprise a bus for communicating information, a processor coupled with the bus for processing information, main memory coupled with the bus for storing information and operating instructions for the processor, a memory element (preferably read-only memory) coupled with the bus for storing static information and operating instructions for the processor, a communication interface (which may be an input device) coupled with the bus for communicating information and command selections to and/or from the processor, and a mass storage device, such as a magnetic disk and associated disk drive, coupled with the bus for storing information and instructions. A data storage medium containing digital information may also be configured to operate with the mass storage device to allow the processor to access to the digital information on the data storage medium via the bus.

The electronic system uses the elements provided to store an electronic database of various types of data, including without limitation, personal data relating to one or more individuals. This information may come from a variety of sources such public registries, federal or state agencies that collect or create personal data (e.g., drivers licenses, assistance cards, census data, voter registrations), but in the preferred embodiment, such information will come from subscribers who authorize the collection of such data.

The computer system may additionally include a display device coupled with the bus for displaying information for a computer user and/or a network device that enables the computer system to connect to a network, such as the Internet and/or a wireless network. With a network device, a user may thus use the computer system to communicate on the network via a web browser or other such user interface. The above-described system is not, however, necessary to practice the invention. It is merely illustrative of a present day system within which the invention may be practiced. Alternative embodiments may include any system capable of receiving, storing, transmitting data to achieve the same or similar functionality described herein.

The present invention discloses a method for protecting various types of personal information associated with individuals and businesses (hereafter collectively “entities”). Such identifiers include, but are not limited to, social security numbers, credit card numbers, driver license numbers, federal employer identification numbers, and passport numbers. The present invention provides benefits to both entities as well as merchants and/or other agencies that these entities interact with. First, it enables subscribers, individuals or entities to register with a centralized security service (hereafter referred to as “lock service”).

The lock service provides each subscriber, individual or entity with a personalized key for each piece of personal information registered in the lock service. These personalized keys can be a code, an electromagnetic signal, a bio-metric (e.g., a finger print or a retinal scan) or any other individualized identifier which the lock service thereafter associates with one of more pieces of information. The lock service will, in response to a query (either by an electromagnetic signal or otherwise), provide verification that the personal information is associated with the individual and not blocked from use, thereby unlocking the information for authorized uses. Alternatively, the lock service can enable merchants and/or other agencies to subscribe to the lock service and verify the identity of entities who provide them with one or more of their personal keys.

The following is an example of applying the above-described method to protect and uniquely verify social security numbers. Although described in relation to social security numbers, the same method may be applied to any other form of identifier that is associated with an entity. According to one embodiment of the present invention, an individual registers his social security number with the lock service. A lock service may be a private company that provides such services to consumers, or a company such as a credit bureau agency or other registered financial institution.

During the registration process, the lock service will authenticate the social security number by checking the number against the Social Security Administration (“SSA”) database. In order to register, in addition to their social security number, an entity must provide the lock service with the same information that would normally be provided to the SSA, such as the name as shown on their social security card, city of birth, date of birth and mother's maiden name. Additionally, the registration may also require other pertinent personal information such as an e-mail address, home address, credit card number or driver's license, permission to validate the social security number with the SSA and a user-id. The lock service may use any and/or all of this information to verify an individual's identity from one or more of the following resources: the SSA, credit bureaus, merchant service companies or other financial institutions.

Once the individual's social security number is authenticated, the lock service generates a personal key associated with the social security number. The individual is provided with the key for future use. Once registered, the individual may provide this key together with their social security number to any third parties desiring to verify his identity. The same methods and apparatus can be used to verify voter rolls at voting sites, identification of persons on entitlement programs (e.g., retirement programs, insurance programs, public assistance programs, etc).

According to one embodiment of the present invention, the lock service may provide the individual with the ability to activate various security options such as a “One-Time Request” and a “Verification Block” feature. This “Verification Block” feature can be selectively applied to numerous pieces of personal information or to a single piece of personal information, e.g. a social security number. The Verification Block feature can also be arranged to automatically alert law enforcement authorities to the attempted use of the personal information.

When the One-Time Request feature is active, the associated social security number personal key automatically becomes disabled immediately after the next personal information validation inquiry. According to one embodiment of the present invention, individuals may request multiple one-time use keys pursuant to the One-Time Request feature. In this instance, each key will become disabled immediately after the next validation of the key holder's social security number (or other private information) validation inquiry. Selection of the One-Time Request feature necessitates the individual to re-enable one or more key(s) associated with the personal information prior to entering any subsequent transaction requiring personal information use or validation.

When the Verification Block option is active as to, for example, a social security number, inquiries by businesses to validate that particular social security number will result in an invalid verification. This is similar to the result of providing an invalid social security number personal key. This failure of verification indicates that submission of that social security number in the transaction is unauthorized. The individual can either opt to de-activate the Verification Block feature so as to authorize the transaction or decline to do so, thereby prohibiting the unauthorized use of the information, for example by way of identity theft.

Once the key holder has set up his account, he may then use the key associated with his social security number to provide authentication of his identity. For example, if the individual goes to a merchant to establish a credit account, the merchant typically requires the individual to fill out an application and provide them with a variety of information, including the individual's social security number. The individual who has registered with the lock service will also be able to provide the merchant with not only his social security number but also with the personal key associated with his social security number. This personal key may be a “One Time Request” personal key or an unrestricted personal key. The merchant who subscribes to the lock service will then be able to use this personal key and social security number to verify the individual's identity.

Having provided the personal key to the merchant, the individual may then desire to change his personal key to prevent anyone else from using it to falsely identify themselves as the individual. The individual may simply login to his account on the lock service and request a new personal key associated with his social security number. The previous personal key will no longer be validly associated with his social security number, thus preventing anyone else from using his social security number.

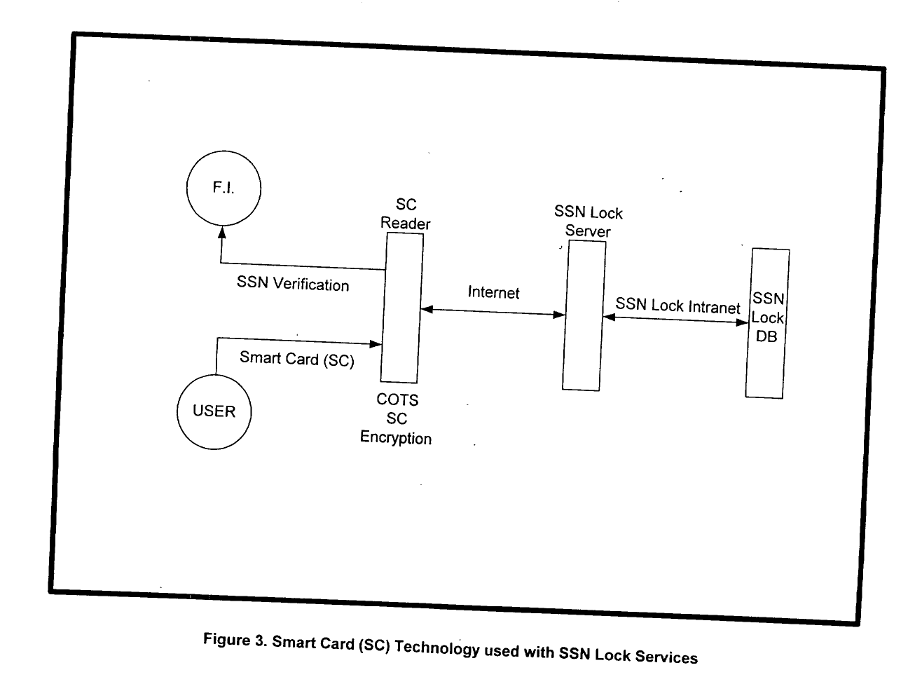

In an alternate embodiment of the present invention, the subscriber may carry a smart card authorized by the lock service that includes the personal key associated with the individual's social security number. According to this embodiment, the individual will not be required to provide the merchant with a personal key and instead would simply be required to provide the merchant with his smart card, which may be automatically read by a card reader, as illustrated in FIG. 3. Individuals may swipe their smart cards into a card reader and enter their key via a key pad. This card reader may then access the lock service via a secure mechanism, such as 128-bit SSL encryption, verify that the social security number matches the key in the lock service database, and then return verification back to the business and/or financial institutions. In yet another embodiment, the lock service may accept hardcopy requests for verification.

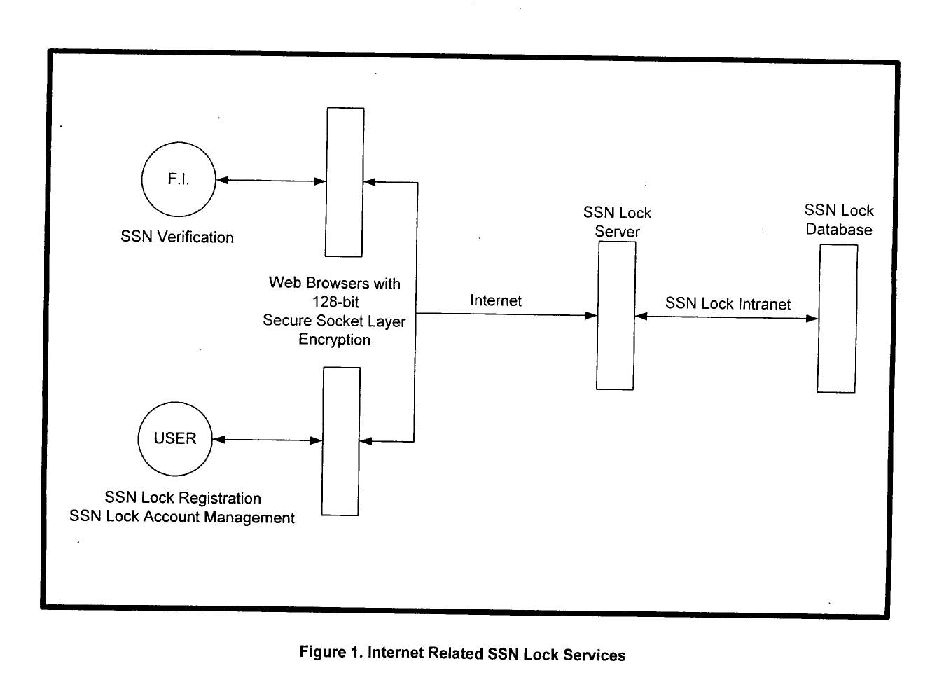

The lock service may provide a variety of user communication interfaces via which an individual may register. According to one embodiment, the user interface is a web browser on an internet-connected computer, as illustrated in FIG. 1—Security on the lock service registration system may be based on existing commercial off the shelf (COTS) technology that utilizes 128-bit secure socket layer (SSL) encryption. This technology has proven to effectively provide secure transfers of credit card information and financial information over the Internet. By utilizing a COTS system, future advancements in encryption technology may be easily integrated into the present invention.

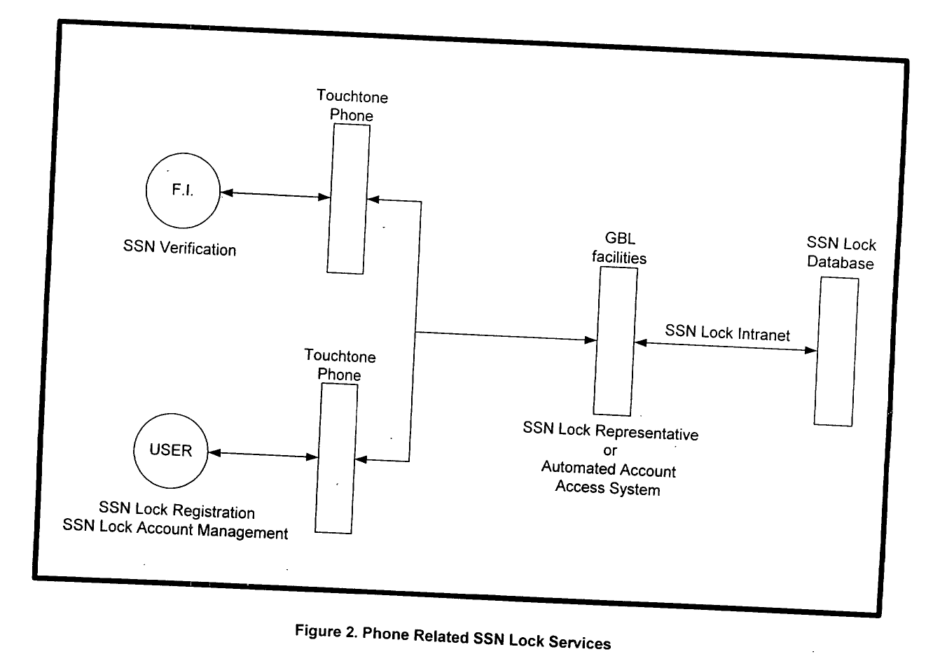

In an alternate embodiment, the interface by which a user registers may be via the telephone, as illustrated in FIG. 2. Phone registration would require an individual to contact a live operator at the third party service to provide personal information. Subsequent account access via the phone may utilize an automated account access system using a touch-tone dial pad and following instructions to update the personal key, to obtain an account history, or to activate/deactivate social security block features. As with the previous option, the technology required to enable secure account access via the telephone is already commercially available. Yet another alternative embodiment would allow a user to submit a hard copy registration form to the lock service for manual processing.

Similarly, business or financial institutions that wish to verify an individual's social security number may do so via one of the following interfaces: (1) accessing the secure database via the Internet utilizing 128-bit SSL encryption; (2) directly contacting the lock service via telephone; (3) using smart card technology; or (4) via hard copy applications. Alternate embodiments of the invention may allow use of additional interfaces.

The lock service website referenced in FIG. 1 provides 24/7 access and enables businesses and financial institutions to immediately identify whether or not an individual is registered and has a personal key established. For parties that are registered, the system will return to the inquiring business or financial institution information regarding whether the personal key correlates to the specified social security number.

As is apparent from the above description, the present invention provides significant benefits to both individuals as well as companies. From the perspective of an individual, for example, the individual is protected from social security number theft (and more generally from identity theft, depending on the personal information that the individual registers with the lock service). Each time the individual provides a social security number to a bank or institution, the individual may then access their lock service account and alter the personal key associated with the social security number. Once this personal key is altered, the information provided to the previous bank or financial institution may no longer be used by unscrupulous third parties to identify the individual. Alternatively, instead of simply altering the personal key associated with the social security number, the individual may instead simply lock his or her account altogether for a predetermined amount of time. Any inquiries that come through during the period that the account is locked will generate an error, thus informing the bank or financial information or department store that the third party attempting to have the social security number authenticated is not the individual who is registered with the lock service. From the perspective of the bank or financial institution or department store, the ability to verify that an individual's social security number actually corresponds to a particular individual is also highly useful, for example, in reducing costly credit card fraud.

Thus, a method and apparatus for protecting personal information and verifying identities is disclosed. Although the present invention has been described with reference to specific exemplary embodiments, it will be evident to those skilled in the art that various changes and modifications may be made to these embodiments, and equivalents may be substituted for elements in these embodiments, without departing from the general spirit and scope of the invention as set forth in the claims. In addition, many modifications may be made to adapt a particular element, technique or implementation to the teachings of the present invention without departing from the central scope of the invention. Accordingly, the specification and drawings should be regarded in an illustrative rather than a restrictive sense.

I claim:

1. A method for verifying the identity of a person, the method comprising the steps of:
a. receiving a personal key from a person whose identity is to be verified;
b. transmitting the personal key to an electronic system, said electronic system containing personal information regarding the individual whose identity is to be verified; and,
c. receiving a confirmation from said computer system that the personal key is linked to the personal information of the individual whose identity is sought to be verified.

2. A method of verifying the identity of a person of claim 1 wherein the personal information is a Social Security Number.

3. A method of verifying the identity of a person of claim 2 wherein the person whose identity is to be verified provides the personal key to a merchant and the merchant transmits the personal key to a lock service in order to verify that the social security number provided by the individual is associated with the personal key at the lock service.

4. A method of verifying the identity of a person of claim 2 wherein the person whose identification is being verified is engaged in a commercial transaction.

5. A method of verifying the identity of a person of claim 3 wherein the personal key is received in response to entering a code on a telephone.

6. A method of verifying the identity of a person of claim 3 wherein the personal key expires after one use.

7. A method of verifying the identity of a person of claim 3 wherein the personal key expires on a date certain.

8. A method for verifying the identity of a person, the method comprising:
a. storing personal information regarding one or more persons in an electronic database;
b. receiving an electromagnetic signal pursuant to which the verification of personal information of one or more persons is requested;
c. verifying that the information in the electromagnetic signal is linked to certain personal information in the electronic database for one or more persons; and
d. confirming that the information in the electromagnetic signal and certain personal information are linked in the computer database.

9. A method of verifying the identity of a person of claim 8 wherein the personal information is a Social Security Number.

10. A method of verifying the identity of a person of claim 8 wherein the person whose identification is being verified is engaged in a commercial transaction.

11. A method of verifying the identity of a person of claim 8 wherein the person whose identity is to be verified provides the personal key to a merchant and the merchant transmits the personal key to a lock service in order to verify that the social security number provided by the individual is associated with the personal key at the lock service.

12. A method of verifying the identity of a person of claim 8 wherein the personal key is received in response to entering a code on a telephone.

13. A method of verifying the identity of a person of claim 8 wherein the personal key expires after one use.

14. A method of verifying the identity of a person of claim 8 wherein the personal key expires on a date certain.

15. A system for protecting personal information comprising:
a. a computer system, said computer system including an electronic data storage device and operating instructions to manipulate data stored in said data storage device;
b. a personal key, said personal key being associated with data stored in said data storage device; and,
c. a communication interface, said communication interface being arranged to receive requests for verification from one or more sources and transmit a result of the manipulation of the data in the data storage device in response thereto.

16. A method of protecting personal information of claim 15, wherein the personal information is a Social Security Number.

17. A method of protecting personal information of claim 16 wherein a verification block is enabled such that any personal key associated with such personal information declines to verify the personal information.

18. A method of protecting personal information of claim 16 wherein the verification block is enabled in response to entering a code on a telephone.

19. A method of protecting personal information of claim 16 wherein the verification block alerts law enforcement authorities to the attempted use.

20. A method of protecting personal information of claim 16 wherein the verification block expires on a date certain.

21. A method for verifying personal information provided to a merchant by an individual in a commercial transaction, the steps comprising:
a. providing a code to the merchant together with personal information;
b. communicating the code and the personal information to computer for verifying that the code and the personal information is linked in the database of the computer; and,
c. receiving a confirmation that the code and the personal information are linked in the database of the computer before consummating the commercial transaction.

22. A method of verifying the identity of a person engaged in a commercial transaction of claim 21, wherein the personal information is a Social Security Number.

23. A method of verifying the identity of a person engaged in a commercial transaction of claim 21 wherein the person whose identity is to be verified provides the personal key to a merchant and the merchant transmits the personal key to a lock service in order to verify that the social security number provided by the individual is associated with the personal key at the lock service.

24. A method of verifying the identity of a person engaged in a commercial transaction of claim 21 wherein the personal key is received in response to entering a code on a telephone.

25. A method of verifying the identity of a person engaged in a commercial transaction of claim 21 wherein the personal key expires after one use.

26. A method of verifying the identity of a person engaged in a commercial transaction of claim 21 wherein the personal key expires on a date certain.

27. A system for protecting personal information, the system comprising:
a. an electronic data storage device, said electronic data storage device containing personal information for at least one individual;
b. a personal key generator, said personal key generator arranged to generate a personal key in response to a request by a person whose information is stored in the electronic data storage device;
c. a communication interface, said communication interface being in selective communication with said electronic data storage device and said personal key generator so as to respond to at least one of: a request for the generation of a personal key, a request to transmit a personal key, and a request to verify that the personal information stored in said electronic storage device is associated with a previously generated personal key.

28. A method of verifying the identity of a person engaged in a commercial transaction of claim 27, wherein the personal information is a Social Security Number.

29. A method of verifying the identity of a person engaged in a commercial transaction of claim 28 wherein the person whose identity is to be verified provides the personal key to a merchant and the merchant transmits the personal key to a lock service in order to verify that the social security number provided by the individual is associated with the personal key at the lock service.

30. A method of verifying the identity of a person engaged in a commercial transaction of claim 28 wherein the personal key is received in response to entering a code on a telephone.

31. A method of verifying the identity of a person engaged in a commercial transaction of claim 28 wherein the personal key expires after one use.

32. A method of verifying the identity of a person engaged in a commercial transaction of claim 28 wherein the personal key expires on a date certain.
